(19) United States
(12) Patent Application Publication
(10) Pub. No.: US 2024/0372059 A1
(43) Pub. Date: Nov. 7, 2024

(54) Electrode Plate, a Manufacturing Method Therefor and a Battery

(71) Applicant: JIANGSU ZENERGY BATTERY TECHNOLOGIES CO., LTD., Suzhou City (CN)

(72) Inventors: Xintian ZHANG, Suzhou City (CN); Juntai LU, Suzhou City (CN); Jianliang WEI, Suzhou City (CN)

(21) Appl. No.: 18/653,956

(22) Filed: May 2, 2024

(30) Foreign Application Priority Data
May 5, 2023 (CN) 202310498014.X

(51) Int. Cl. H01M 4/04

(52) U.S. Cl. CPC H01M 4/0435; H01M 4/0407; H01M 4/0471

(57) ABSTRACT

The present invention discloses an electrode plate, a manufacturing method therefor and a battery. The manufacturing method for an electrode plate comprises: obtaining at least two active material films; stacking the at least two active material films, the fiberization directions of the two adjacent active material films being perpendicular to each other or forming an included angle, and applying a conductive glue between two adjacent active material films; rolling the stacked at least two active material films to obtain an electrode film; and combining the electrode film with a current collector to obtain the electrode plate. The manufacturing method of the present disclosure can improve the strength of the electrode film, and thus the electrode film is not prone to cracking. The included angle is formed between the fiberization directions of the two adjacent active material films, so that the electrode plate is prone to cracking are solved.

### TECHNICAL FIELD

The present disclosure relates to the field of battery technology, and in particular, to an electrode plate, a manufacturing method therefor, and a battery.

### BACKGROUND

The degree of fiberization of an active material on an electrode plate is a key factor in dry electrode technology. Taking PTFE (polytetrafluoroethylene) as an embodiment, there are currently many methods to increase the degree of fiberization of PTFE, including but not limited to high-speed stirring, step-by-step feeding, airflow grinding, baking, self-supporting, etc. However, the current effects achieved by these methods are not ideal, and some methods may even cause side effects to each other when used in combination. For example, baking will make fiberization be easily occurred in the rolling film forming process, but it will also destroy the structure of some PTFE that is already subjected to fiberization or has a fiberization tendency. Another embodiment is that the degree of fiberization in the longitudinal direction is better, but the degree of fiberization in the transverse direction is poor. Therefore, the fiberization effects of the current processes are poor, the strength of the electrode plates is poor, and problems such as cracking are prone to occur.

In view of this, the present disclosure is filed.

### SUMMARY

The purpose of the present disclosure is to provide an electrode plate, a manufacturing method therefor, and a battery. The manufacturing method can improve the strength of the electrode plate and alleviate the problem of easy cracking.

The present disclosure is implemented as follows:

In a first aspect, the present disclosure provides a manufacturing method for an electrode plate, comprising:

Obtaining at least two active material films;

Stacking the at least two active material films, wherein the fiberization directions of the two adjacent active material films forming an included angle, and applying a conductive glue between the two Adjacent active material films;

Rolling the stacked at least two active material films to obtain an electrode film; and

Combining the electrode film and a current collector to obtain the electrode plate.

In an optional embodiment, the fiberization directions of the two adjacent active material sheets are perpendicular to each other.

In an optional embodiment, the step of obtaining at least two active material films comprises:

Mixing and stirring an active e material, a conductive agent, polytetrafluoroethylene and an additive to obtain mixed powder; and

Subjecting the mixed powder to shaping in a roller press to obtain the active material film.

In an optional embodiment, the roller surface temperature of the roller press is 40-240° C.

In an optional embodiment, before rolling the stacked at least two active material films, the thickness of the conductive glue is 1-20 μm.

In an optional embodiment, in the step of rolling the stacked at least two active material films, the roller surface temperature is 100-130° C., and the rolling speed is 1-1.5 m/min.

In an optional embodiment, before the step of combining the electrode film with a current collector, the manufacturing method for an electrode plate also comprises:

Subjecting the electrode film which obtained by rolling to thinning treatment.

In an optional embodiment, the thinning treatment is realized by hot pressing.

In an optional embodiment, before the thinning treatment, the thickness of the electrode film is 150-165 μm; the thickness of the electrode film used for an anode plate is 65-75 μm after the thinning treatment, and the thickness of the electrode film used for a cathode plate is 50-60 μm after the thinning treatment.

In an optional embodiment, in the step of combining the electrode film and the current collector, a flat plate hot press is used for combination. The surface temperature of the flat plate hot press is 185° C., and the pressure is 2-6.7 MPa.

In a second aspect, the present disclosure provides an electrode plate, which is manufactured by the manufacturing method for an electrode plate in any one of the preceding embodiments.

In a third aspect, the present disclosure provides a battery, comprising the electrode plate of the described embodiment.

The present disclosure has the following beneficial effects:

The manufacturing method for an electrode plate of the present disclosure comprises obtaining at least two active material films. The manufacturing method provided by the present disclosure improves the combination property of the active material films by applying the conductive glue between two adjacent active material films, thereby increasing the strength of the electrode film and making it less likely crack. Further, the conductive glue also reduces the film surface resistance, making the electrode plate better conductive. By making the fiberization directions of the two adjacent active material films form an included angle, a fiberization network of the electrode film can be constructed, which effectively increases the mechanical strength of the electrode plate and improves the problem of low lateral strength in a single rolling process and easy cracking of the electrode plate.

### BRIEF DESCRIPTION OF THE DRAWINGS

In order to more clearly illustrate the technical solutions of the embodiments of the present disclosure, the drawings required to be used in the embodiments will be briefly introduced below. It should be understood that the following drawings only show some embodiments of the present disclosure and therefore should not be regarded as a limitation of the scope. For those of ordinary skill in the art, other relevant drawings can be obtained based on these drawings without exerting creative efforts.

FIG. 1 is a flow chart of a manufacturing method for an electrode plate in an embodiment of the present disclosure;

FIG. 2 is a schematic diagram of stacking two active material films and a conductive glue therebetween in an embodiment of the present disclosure.

Explanation of main component symbols: 100—active material film; 200—conductive glue.

### DETAILED DESCRIPTION OF THE EMBODIMENTS

In the existing dry electrode manufacturing process, one-time rolling is used to achieve fiberization, and after the one-time rolling, the degree of fiberization in the longitudinal direction is good, but the fiberization in the transverse direction is poor. Although a method comprising multiple folding and rolling solves this problem to a certain extent, it also causes the electrode plate to be too dense and difficult to thin. Further, this method is inefficient, cumbersome to operate, and difficult to control quality. In view of the current problems of dry electrodes having poor transverse or longitudinal strength due to insufficient fiberization in all directions and being difficulty in thinning after multiple folding and rolling, the present disclosure provides a manufacturing method for a dry electrode plate which has certain strength in both the longitudinal and transverse directions, and the manufacturing method is easy to operate and achieve mass production, can reduce the surface resistance, and can obtain a suitable thickness after thinning. In addition, the present disclosure also provides an electrode plate produced by the manufacturing method and a battery comprising the electrode plate.

In order to make the purpose, technical solutions and advantages of the embodiments of the present disclosure clearer, the technical solutions in the embodiments of the present disclosure will be clearly and completely described below. If specific conditions are not specified in the embodiments, the conditions should be carried out according to conventional conditions or conditions recommended by the manufacturer. If the manufacturers of the reagents or instruments used are not indicated, they are all conventional products that can be purchased commercially.

The features and properties of the present disclosure will be described in further detail below in conjunction with embodiments.

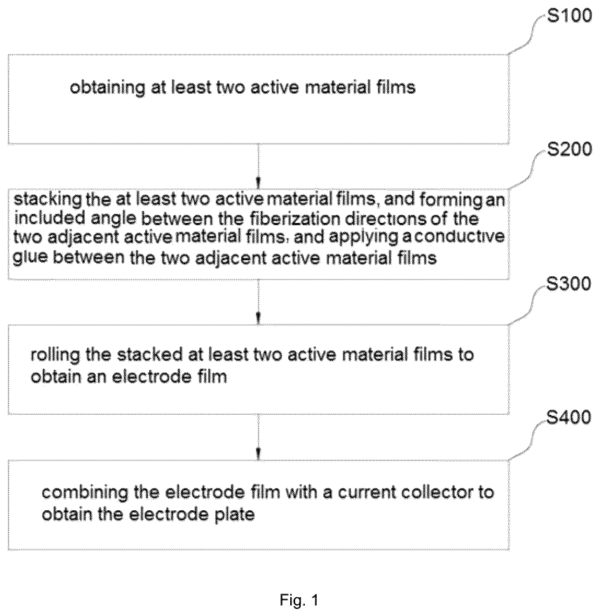

FIG. 1 is a flow chart of a manufacturing method for an electrode plate in an embodiment of the present disclosure. As shown in FIG. 1, the manufacturing method for an electrode plate provided by the embodiment of the present disclosure comprises:

Step S100: obtaining at least two active material films.

In the embodiments of the present disclosure, the active material film is used for subsequent production of an electrode film. Specifically, the step S100 may comprise the following steps:

Step S110, mixing and stirring an active material, a conductive agent, polytetrafluoroethylene and additives to obtain mixed powder;

Step S120: subjecting the mixed powder to milling and shaping by means of open-rolling same in a roller press to obtain an active material film.

Optionally, the method for manufacturing the electrode plate provided in the embodiment of the present disclosure can be used to manufacture either a cathode plate or an anode plate. When manufacturing a cathode plate, the active material should be a cathode active material (such as NCM, LFP, LCO, and LMO); correspondingly, when manufacturing an anode plate, the active material should be an anode active material.

Optionally, the conductive agent includes but is not limited to SP, CSX, CNT, etc.

Optionally, in step S110, the active material, the conductive agent, polytetrafluoroethylene (PTFE) and the additive can be granulated by high-speed stirring in a stirring tank to obtain mixed powder. The specific steps may include: putting the active material and the conductive agent into the stirring tank, stirring at a stirring rate of 3200 r/min for 10-15 min; adding PTFE and additive powder, and stirring at a stirring rate of 4000 r/min for 5 min to obtain mixed powder.

Optionally, in the step S120, the roller surface temperature of the roller press during the milling and shaping process of the mixed powder is 40-240° C. For example, the roller surface temperature is any value of 40° C., 60° C., 80° C., 100° C., 120° C., 140° C., 160° C., 180° C., 200° C., 220° C. and 240° C. or a value between any two values. The roller press can be a vertical roller press.

Optionally, the thickness of the produced active material film is 80-125 μm.

In step S200, at least two active material films are stacked, and the fiberization directions of the two adjacent active material films form an included angle, the conductive glue is applied between two adjacent active material films.

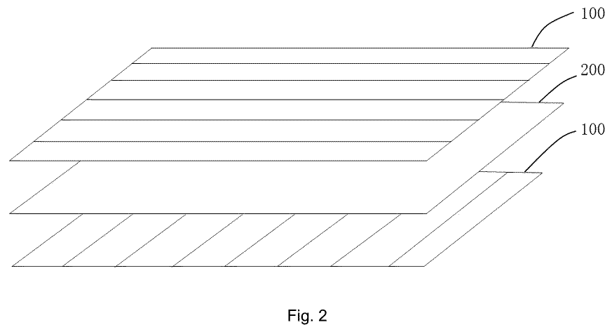

FIG. 2 is a schematic diagram of stacking two active material films 100 and a conductive glue 200 therebetween in the embodiment of the present disclosure. As shown in FIG. 2, the extending direction of the stripes on the active material film 100 is the fiberization direction. Optionally, two active material films 100 can be stacked, or three or more active material films 100 can be stacked as needed.

Optionally, the fiberization directions of the two adjacent active material films 100 are perpendicular to each other, so that the degree of fiberization in all directions of the manufactured electrode plate is more uniform and the anisotropy is reduced.

After the active material films 100 are stacked, the sizes of the active material films 100 can be made consistent by cutting. For example, in an optional embodiment, the active material film 100 can be cut into a length of 80 cm and a width of 40 cm.

Optionally, before rolling the stacked at least two active material films 100, the thickness of the conductive glue 200 between the two adjacent active material films 100 is 1-20 μm; optionally, the thickness of the conductive glue 200 is 5-15 μm; further, the thickness of the conductive glue 200 is 8-10 μm. The conductive glue 200 can not only ensure the bonding strength between the active material films 100, but also ensure that the subsequently obtained electrode film has better conductivity. Too much conductive glue 200 may lead to a decrease in the proportion of the active materials in the electrode film, thereby affecting the properties; and too little conductive glue 200 may lead to a decrease in the conductivity, strength and other parameters of the electrode film.

The conductive glue 200 includes, but is not limited to, epoxy resin conductive glue, acrylic resin conductive glue, polyimide resin conductive glue, phenolic resin conductive glue, etc.

In step S300: the stacked at least two active material films are rolled to obtain an electrode film.

Optionally, during the rolling process of the stacked active material films 100, the rolling pressure is 9 t, and the roller surface temperature is 40-240° C.; further, the roller surface temperature can be optionally 100-130° C. The roller speed can be selected from 1-1.5 m/min, such as 1 m/min, 1.1 m/min, 1.2 m/min, 1.3 m/min, 1.4 m/min or 1.5 m/min. The active material films 100 can be combined together by rolling, and the purpose of drying the conductive glue 200 can be achieved at the same time. The thickness of the combined film after this rolling can be selected from 150-165 μm.

Optionally, step S300 also comprises thinning the electrode film obtained by rolling. Specifically, the combined film obtained above can still be thinned by hot pressing. The thickness of the combined film before thinning is 150-165 μm. The thickness of the electrode film obtained after thinning can be selected according to needs. For example, the thickness of the electrode film used for the anode plate after thinning is 65-75 μm, and the thickness of the electrode film used for the cathode plate after thinning is 50-60 μm. It should be understood that the final thickness of the thinning process can also be other values outside the above range according to needs. For example, the electrode film applied to the anode plate can be thinned to a minimum of 46 μm. In some optional embodiments, the thinning treatment may not be performed, and the combined film after rolling may be used as the electrode film.

Thinning can be achieved by passing the combined film over a roll. In an optional embodiment, the rolling pressure is 11.5 t, and the roll surface temperature is 65° C. (for manufacturing the cathode film) or 115° C. (for making the anode film).

In step S400, the electrode film and a current collector are combined to obtain an electrode plate.

In an optional embodiment, a flat plate hot press is used for combination; optionally, the surface temperature of the flat plate hot press is 185° C., the pressure is 2-6.7 MPa, and the hot pressing time is not less than 2.5 s. The current collector can use hot-melt gravure foil (such as copper foil).

The battery provided in the embodiment of the present disclosure comprises the electrode plate produced by the manufacturing method provided by the present disclosure.

In the electrode plate produced by the manufacturing method provided in the embodiment of the present disclosure, the electrode film has a fibrous network structure, so it has better tensile strength in the transverse direction and the longitudinal direction (consistent with the two fiberization directions respectively). The beneficial effects of the embodiments of the present disclosure are introduced below in combination with different embodiments, comparative embodiments and tests.

### Embodiment 1

The manufacturing method of this embodiment was used to manufacture a cathode plate, comprising:
1) Putting a positive active material NCM and a conductive agent into a stirring tank, stirring at 3200 r/min for 10-15 min, then adding PTFE and additive powder, and mixing evenly at 4000 r/min for 5 min to obtain mixed powder;
2) Rolling the mixed powder by means of a roller press to obtain active material film, placing the two active material films vertically in the direction of fiberization, and cutting same to the same size, 80 cm long and 40 cm wide, wherein the thickness of each active material film is 110-125 μm, and the fiberization directions of the two active material films are consistent with the length and width directions, respectively;
3) Coating an epoxy resin conductive glue with the thickness being 10 μm between the two active material films, laminating the two active material films, and passing same through a hot roller with a surface temperature of 115° C. at a speed of 1.4 m/min for combination, wherein the thickness after combination is 150-165 μm;
4) Thinning the combined film again by hot pressing to obtain a cathode film with a thickness of 50-60 μm; and
5) Combining the electrode film and a current collector by means of hot pressing on a flat plate hot press with a flat plate temperature of 185° C., a pressure of 3.5 MPa, and a hot pressing time of 3 s.

### Embodiment 2

The manufacturing method of this embodiment was used to manufacture an anode plate, comprising:
1) Putting a negative active material (graphite) and a conductive agent into a stirring tank, stirring at 3200 r/min for 10-15 min, then adding PTFE and additive powder, and mixing evenly at 4000 r/min for 5 min to obtain mixed powder;
2) Rolling the mixed powder by means of a roller press to obtain active material film, placing the two active material films vertically in the direction of fiberization, and cutting same to the same size, 80 cm long and 40 cm wide, wherein the thickness of each active material film is 80-100 μm, and the fiberization directions of the two active material films are consistent with the length and width directions, respectively;
3) Coating an epoxy resin conductive glue with the thickness being 10 μm between the two active material films, laminating the two active material films, and passing same through a hot roller with a surface temperature of 115° C. at a speed of 1.4 m/min for combination, wherein the thickness after combination is 140-160 μm;
4) Thinning the combined film again by hot pressing to obtain an anode film with a thickness of 65-75 μm; and
5) Combining the electrode film and a current collector by means of hot pressing on a flat plate hot press with a flat plate temperature of 185° C., a pressure of 3.5 MPa, and a hot pressing time of 3 s.

### Comparative Embodiment 1

In this comparative embodiment, a cathode plate was produced. The method comprises:
1) Putting a positive active material NCM and a conductive agent into a stirring tank, stirring at 3200 r/min for 10-15 min, then adding PTFE and additive powder, and mixing evenly at 4000 r/min for 5 min to obtain mixed powder;
2) Rolling the mixed powder by means of a roller press to obtain active material film, 80 cm long, 40 cm wide, and 110-125 μm thick, wherein the fiberization direction is consistent with the length direction;
3) Thinning by hot pressing to obtain a cathode film with a thickness of 50-60 μm; and
4) Combining the electrode film and a current collector by means of a flat plate hot press with a flat plate temperature of 185° C., a pressure of 3.5 MPa, and a hot pressing time of 3 s.

### Comparative Embodiment 2

In this comparative embodiment, an anode plate was produced. The method comprises:
1) Putting a negative active material (graphite) and a conductive agent into a stirring tank, stirring at 3200 r/min for 10-15 min, then adding PTFE and additive powder, and mixing evenly at 4000 r/min for 5 min to obtain mixed powder;
2) Rolling the mixed powder by means of a roller press to obtain active material film, 80 cm long, 40 cm wide, and 80-100 μm thick, wherein the fiberization direction is consistent with the length direction;
3) Thinning by hot pressing to obtain an anode film with a thickness of 65-75 μm; and
4) Combining the electrode film and a current collector by means of a flat plate hot press with a flat plate temperature of 185° C., a pressure of 3.5 MPa, and a hot pressing time of 3 s.

Electrode films were produced in the manner of the above-mentioned Embodiments 1 and 2 and Comparative embodiments 1 and 2, and the tensile properties of the electrode films were tested. The tensile strength of the electrode films of each embodiment and comparative embodiment was tested eight times each in the length direction and width direction. The test results were shown in the table below.

| | Test | | | | | | | | |
|---|---|---|---|---|---|---|---|---|---|
| Group | direction | Tensile strength (unit N/m²) | | | | | | | |
| Embodiment 1 | Length | 17.52 | 17.21 | 17.99 | 19.47 | 18.95 | 19.36 | 18.25 | 17.18 |
| | direction | | | | | | | | |
| | Width | 11.26 | 9.58 | 11.53 | 10.11 | 12.05 | 11.54 | 11.17 | 10.31 |
| | direction | | | | | | | | |
| Embodiment 2 | Length | 16.33 | 16.89 | 16.25 | 17.83 | 15.69 | 17.59 | 16.34 | 15.86 |
| | direction | | | | | | | | |
| | Width | 11.54 | 12.26 | 11.87 | 10.81 | 12.53 | 11.29 | 11.94 | 11.47 |
| | direction | | | | | | | | |
| Comparative | Length | 16.32 | 15.87 | 18.11 | 16.75 | 17.22 | 18.94 | 15.78 | 17.45 |
| embodiment 1 | direction | | | | | | | | |
| | Width | 4.21 | 4.85 | 4.33 | 4.56 | 4.47 | 5.15 | 4.43 | 5.37 |
| | direction | | | | | | | | |
| Comparative | Length | 14.53 | 15.62 | 14.89 | 13.65 | 16.23 | 15.57 | 13.87 | 14.09 |
| embodiment 2 | direction | | | | | | | | |
| | Width | 6.72 | 6.83 | 7.05 | 5.84 | 5.12 | 6.09 | 6.65 | 6.54 |
| | direction | | | | | | | | |

As could be determined from the table above, the average tensile strength (18.24 N/m²) of the cathode film in the length direction of Embodiment 1 was slightly better than the average tensile strength of the cathode film in the length direction of Comparative embodiment 1 (17.06 N/m²); and the average tensile strength of the cathode film in the width direction of Embodiment 1 (10.94 N/m²) was significantly better than the average tensile strength of the cathode film in the width direction of Comparative embodiment 1 (4.67 N/m²). The average tensile strength in the length direction of the anode film of Embodiment 2 (16.6 N/m²) was slightly better than the average tensile strength of the anode film in the length direction of Comparative embodiment 2 (14.81 N/m²); and the average tensile strength in the width direction of the anode film of Embodiment 2 (11.71 N/m²) was significantly better than the average tensile strength in the width direction of the anode film of Comparative embodiment 2 (6.36 N/m²). In Embodiments 1 and 2 of the present disclosure, two active material films were stacked and combined, and the fiberization directions of the two active material films are perpendicular to each other to form a fibrous network structure. Compared with the cases where two (or more) active material films were not stacked of Comparative embodiments 1 and 2, the tensile strength was obviously optimized.

To sum up, the manufacturing method for an electrode plate of the present disclosure comprised obtaining at least two active material films; stacking the at least two active material films, and applying a conductive glue between the two adjacent active material films, the fiberization directions of the two adjacent active material films were perpendicular to each other or form an included angle therebetween; rolling the stacked at least two active material films to obtain an electrode film; and combining the electrode film and a current collector to obtain the electrode plate. The manufacturing method provided by the present disclosure improved the combination property of the active material films by applying the conductive glue between two adjacent active material films, thereby increasing the strength of the electrode film and making it less likely crack. Further, the conductive glue also reduced the film surface resistance, making the electrode plate better conductive. By making the fiberization directions of the two adjacent active material films form an included angle, a fiberization network of the electrode film could be constructed, which effectively increases the mechanical strength of the electrode plate and improved the problem of low lateral strength in a single rolling process and easy cracking of the electrode plate.

The above descriptions are only preferred embodiments of the present disclosure and are not intended to limit the present disclosure. For those skilled in the art, the present disclosure may have various modifications and changes. Any modifications, equivalent replacements, improvements, etc. made within the spirit and principles of the present disclosure shall be included in the scope of protection of the present disclosure.

What is claimed is:

1. A manufacturing method for an electrode plate, comprising:
obtaining at least two active material films;
stacking the at least two active material films, forming an included angle between the fiberization directions of the two adjacent active material films, and applying a conductive glue between the two adjacent active material films;
rolling the stacked at least two active material films to obtain an electrode film; and
combining the electrode film and a current collector to obtain the electrode plate.

2. The manufacturing method for an electrode plate according to claim 1, wherein the step of obtaining at least two active material films comprises:
mixing and stirring an active material, a conductive agent, polytetrafluoroethylene and an additive to obtain mixed powder; and
subjecting the mixed powder to shaping in a roller press to obtain the active material film.

3. The manufacturing method for an electrode plate according to claim 2, wherein the roller surface temperature of the roller press is 40-240° C.

4. The manufacturing method for an electrode plate according to claim 1, wherein before rolling the stacked at least two active material films, the thickness of the conductive glue is 1-20 μm.

5. The manufacturing method for an electrode plate according to claim 2, wherein in the step of rolling the stacked at least two active material films, the roller surface temperature is 100-130° C., and the roller speed is 1-1.5 m/min.

6. The manufacturing method for an electrode plate according to claim 1, wherein before the step of combining the electrode film and the current collector, the manufacturing method for an electrode plate further comprises:
subjecting the electrode film obtained by rolling to thinning treatment.

7. The manufacturing method for an electrode plate according to claim 6, wherein the thinning treatment is implemented by hot pressing.

8. The manufacturing method for an electrode plate according to claim 6, wherein before the thinning treatment, the thickness of the electrode film is 150-165 μm; the thickness of the electrode film used for an anode plate is 65-75 μm after the thinning treatment, and the thickness of the electrode film used for a cathode plate after the thinning treatment is 50-60 μm.

9. The manufacturing method for an electrode plate according to claim 1, wherein in the step of combining the electrode film and the current collector, a flat plate hot press is used for combination, and the surface temperature of the flat plate hot press is 185° C., and the pressure is 2-6.7 MPa.

10. The manufacturing method for an electrode plate according to claim 1, wherein the fiberization directions of the two adjacent active material films are perpendicular to each other.

11. An electrode plate, wherein, the electrode plate produced by the manufacturing method for an electrode plate according to claim 1.

12. A battery, wherein, the battery comprises the electrode plate according to claim 11.

13. An electrode plate, the electrode plate comprises a current collector, wherein the current collector is provided with a conductive adhesive layer and at least two adjacent active material films, the conductive adhesive layer is separately distributed between two adjacent active material films, and the fiber fiberization directions of the two adjacent active material films form an included angle.

14. The manufacturing method for an electrode plate according to claim 4, wherein, the thickness of the conductive glue 200 is 5-15 μm; further, the thickness of the conductive glue 200 is 8-10 μm.
